(19) United States
(12) Patent Application Publication
(10) Pub. No.: US 2026/0337976 A1
(43) Pub. Date: Oct. 29, 2026

(54) INTERMEDIATE SUPPORT

(71) Applicant: A. RAYMOND ET CIE, GRENOBLE (FR)

(72) Inventor: Alban LENGAIGNE, GRENOBLE (FR)

(21) Appl. No.: 19/657,622

(22) Filed: Apr. 24, 2026

(30) Foreign Application Priority Data
Apr. 28, 2025 (FR) 2504482

(51) Int. Cl. E04F 13/08; F16M 13/02

(52) U.S. Cl. CPC E04F 13/0807; F16M 13/022

(57) ABSTRACT

The present disclosure proposes an adjustable intermediate support (100), comprising a base (20) and a clip (40), the base (20) having a contact surface and being provided with fastening means (24) and a threaded hole (26), the threaded hole (26) opening at the contact surface, the clip (40) comprising a clip head (44) and a threaded rod (46), the threaded rod (46) being adapted to be inserted into the threaded hole (26), the clip head (44) being intended to cooperate with a furring strip.

### CROSS-REFERENCE TO RELATED APPLICATION

This application is based on and claims priority under 35 U.S.C. § 119 to French Patent Application No. 2504482, filed on Apr. 28, 2025, in the French National Intellectual Property Office, the disclosure of which is incorporated by reference herein in its entirety.

### BACKGROUND

### 1. Field

The present disclosure relates to an intermediate support, in particular an adjustable intermediate counter-wall support intended for the installation of an interior or exterior covering such as insulation on a wall.

### 2. Prior Art

Known intermediate wall panel support systems have several limitations, particularly with regard to their adaptability to different insulation thicknesses. These systems generally comprise:
a threaded rod with two ends
a first bracket at one end for attachment to the wall
a second bracket at the other end to support the furring strip
an adjustment mechanism on the second bracket.

The main disadvantage of these systems lies in their lack of flexibility to absorb variations in insulation thickness. To adapt them to thicker or thinner insulation, it is often necessary to cut the threaded rod, which makes installation more cumbersome and limits the possibility of reusing the device. This constraint results in more laborious adjustments on site, longer installation times, and a risk of degradation of insulating performance. Furthermore, the installation of the first bracket requires the prior installation of a first framework attached to the wall support, while the second bracket must be placed on a second framework.

### SUMMARY

The present disclosure aims to solve this problem by providing an adjustable intermediate support that easily adapts to various insulation thicknesses without requiring modification of the rod. This solution allows for greater versatility of use, faster installation, and better overall performance of the insulation system.

According to a first aspect of the present disclosure, the adjustable intermediate support, comprising a base and a clip, the base having a contact surface and being provided with fastening means allowing the base to be attached to a support and with a threaded hole, the threaded hole opening at the contact surface, the clip comprising a clip head and a threaded rod, the threaded rod being adapted to be inserted into the threaded hole by screwing, the clip head being intended to cooperate with a furring strip.

In one embodiment, the fastening means are in the form of a hole opening at the contact surface.

In one embodiment, the clip is provided with a flange disposed between the clip head and the rod.

In one embodiment, the contact surface is substantially flat.

In one embodiment, the flange and the clip head define a space adapted to receive the inner lateral flaps of a furring strip.

In one embodiment, the bore constituting the threaded hole extends projecting from the contact surface.

In one embodiment, the base has a substantially rectangular shape.

In one embodiment, the clip is made in one piece.

In one embodiment, the intermediate support is made of plastic material.

According to another aspect of the disclosure, a method for installing an adjustable intermediate support according to the present disclosure comprises the following steps:
attaching the base to a wall support by the fastening means;
screwing the threaded clip into the threaded hole of the base, also through the rigid insulation;
clipping a furring strip onto the clip head.

In one embodiment, the step of attaching the base is performed using a wall plug, through the fastening means in the form of a hole, passing through a rigid insulation.

In one embodiment, the method for installing an adjustable intermediate support further comprises the following step:
adjusting the screwing of the threaded rod into the rigid insulation, this allows adjustment of the spacing between the insulation and the clip head.

### BRIEF DESCRIPTION OF DRAWINGS

Other advantages, aims, and features of the present disclosure will become apparent from the following description made, for explanatory and in no way limiting purposes, with reference to the accompanying drawings, in which:

FIG. 1 represents a perspective view of an adjustable intermediate support comprising a base and a clip according to the present disclosure;

FIG. 2A represents a perspective view of a base of an intermediate support according to the present disclosure;

FIG. 2B represents a perspective view of a threaded clip of an adjustable intermediate support according to the present disclosure;

FIG. 2C represents a side view of a base of an intermediate support according to the present disclosure;

FIG. 2D represents a side view of a threaded clip of an adjustable intermediate support according to the present disclosure;

FIG. 3 represents a cross-sectional view of an adjustable intermediate support comprising a base and a clip according to the present disclosure;

FIG. 4A represents a perspective view of a furring strip mounted on a rigid insulation and a wall support using an adjustable intermediate support according to the present disclosure;

FIG. 4B represents a detailed view of zone A of FIG. 4A;

FIG. 4C represents a cross-sectional view of the assembly of FIG. 4A;

FIG. 5A represents a perspective view of a furring strip mounted on a rigid insulation, a second insulation, and a wall support using an adjustable intermediate support according to the present disclosure;

FIG. 5B represents a cross-sectional view of the assembly of FIG. 5A;

FIG. 6A represents a perspective view of a furring strip mounted on an exterior wall support without insulation using an adjustable intermediate support according to the present disclosure; and

FIG. 6B represents a detailed view of zone B of FIG. 6A.

### DETAILED DESCRIPTION

The different figures as well as the elements of a same figure are not necessarily represented at the same scale. Throughout all the figures, identical elements bear the same numerical reference.

The terminology used in the present description should in no way be interpreted in a limiting or restrictive manner, simply because it is used in conjunction with a detailed description of certain embodiments of the disclosure.

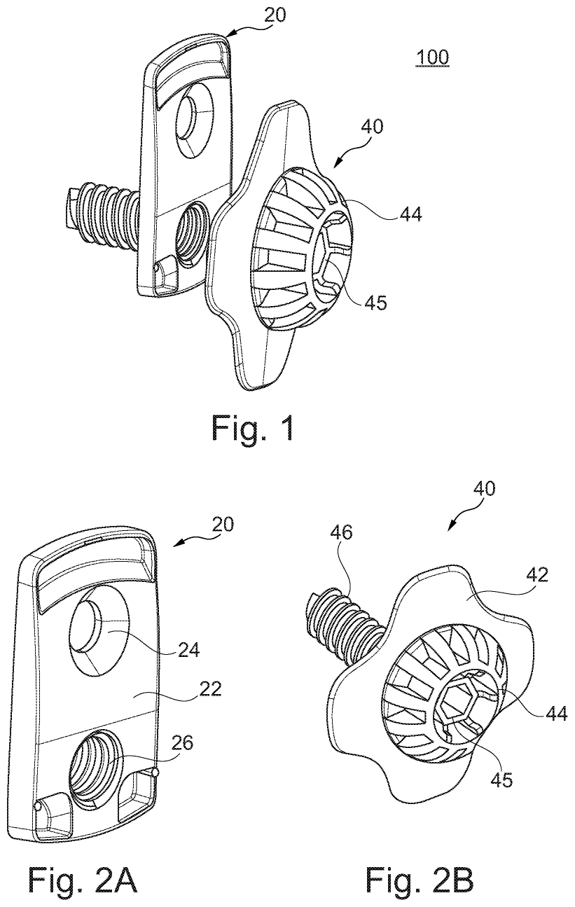

FIG. 1 illustrates a perspective view of an adjustable intermediate support 100 according to the present disclosure. As can be observed, this support comprises two main elements: a base 20 and a furring clip 40.

The adjustable intermediate support 100 according to the disclosure can be manufactured by molding known plastic material, for example by thermoplastic injection, more particularly in engineering plastics such as polyamides, acetal resins, thermoplastic polyesters. Preferably, the adjustable intermediate support 100 is made of known materials allowing resistance to aging and temperature.

In a typical interior insulation application, a furring strip is used, that is to say a “C” profile provided with small inner lateral returns (or fins), serving as a support for facing panels, such as plasterboards. These furring strips are generally made of metal.

The wall panel is generally rectangular, but can also adopt other shapes, such as square or hexagonal. It can be manufactured from various materials such as plaster, cement, polystyrene, wood, or any other appropriate material.

The insulating materials used may include expanded polystyrene, expanded polyurethane, mineral wools, rock wool, glass wool, expanded perlite, wood wool, expanded cork, or wood fibers. For rigid insulation, expanded polyurethane is a common option.

The adjustable intermediate support can advantageously be manufactured from composite material, such as plastic, in order to limit thermal bridges between the wall support and the furring strip.

Generally speaking, the adjustable intermediate support 100 comprises a base 20 and a clip 40, the base having a contact surface and being provided with fastening means allowing the base to be attached to a support and with a threaded hole, the threaded hole opening at the contact surface, the clip comprising a clip head and a threaded rod, the threaded rod being adapted to be inserted into the threaded hole by screwing, the clip head being intended to cooperate with a furring strip.

It should be noted that the base can be attached to a wall support, either directly or indirectly through an insulation, by means of any appropriate fastening device, such as, for example:
screwing
spacing (with hammer-in wall plug)
bonding
magnetism:
presence of a magnet in the base, and presence of a metal plate attached to the insulation
encapsulation:
presence of a box on the insulation into which the base slides
clipping:
clipping onto a threaded rod (for example of the quickie type)
two-piece base that clips laterally onto an element fixed in the wall support
lateral clipping of the base onto an element fixed in the wall support

In the illustrated embodiment, the fastening means are in the form of a hole 24. The attachment of the intermediate support to the wall support is then done by spacing with a hammer-in wall plug in this embodiment.

In the figures accompanying the present application, the fastening means are illustrated with a hole 24 opening at the contact surface. However, the person skilled in the art will understand that it is possible to achieve this attachment by means of any appropriate device, as described previously. The same applies to the method for installing an adjustable intermediate support according to the present disclosure.

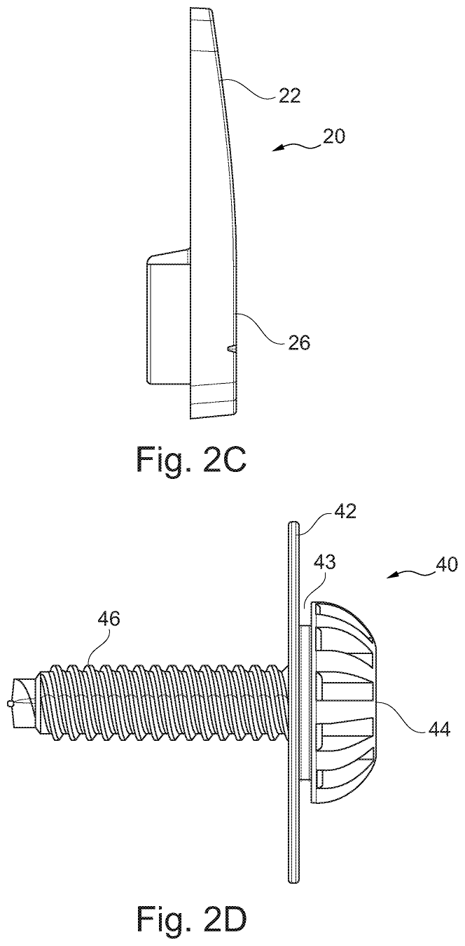

FIG. 2A represents a perspective view of a base 20 of an intermediate support according to the present disclosure. The base 20 comprises a body 22 of generally rectangular shape.

The body 22 has two distinct openings: the fastening means in the form of a circular hole 24 located in the upper part, intended to receive a fastening element for anchoring to the wall support, and a threaded hole 26 positioned in the lower part for engagement with the furring clip 40.

The base 20 comprises a contact surface intended to come into contact with a rigid insulation or a wall support. The two holes 24, 26 open at the contact surface.

Optionally, the contact surface is advantageously flat, this will be detailed later.

Advantageously, the base integrates structural reinforcements and transitions between the different sections of the base.

Advantageously, the furring clip 40 is preferably made in one piece.

FIG. 2B illustrates a perspective view of a furring clip 40. This clip comprises a threaded rod 46 and a mushroom-shaped clip head 44 at one end of the clip. The clip head is advantageously adapted to allow direct clipping of a furring strip. The threaded rod 46 extends from the clip head 44. This threaded rod 46 is advantageously adapted to engage in the threaded hole 26 of the base 20, thus advantageously allowing adjustment of the distance between the clip head 44 and the base 20.

In one embodiment, the clip head 44 comprises a circular plate with a surface having a recess 45, this allows receiving a tool for screwing and unscrewing the clip.

In one embodiment, the clip advantageously comprises a flange 42 between the threaded rod 46 and the clip head 44. A slot 43 may be present between the flange 42 and the clip head 44. The slot 43 is advantageously adapted to receive the small inner lateral returns, once the furring strip is clipped onto the clip head 44.

Optionally, the flange 42 adopts an ergonomic configuration that facilitates gripping and, consequently, the screwing or unscrewing of the furring clip 40.

FIG. 2C shows a side view of the base 20.

In an optional embodiment, the contact surface of the base is substantially flat, which improves the adhesion between the base and the insulation on which it rests.

In another optional embodiment, the bore constituting the threaded hole 26 extends projecting from the contact surface, forming a protuberance. This configuration allows better grip and deeper engagement with the threaded rod 46 of the furring clip 40.

FIG. 2D illustrates, in orthogonal side view, the furring clip 40. The threaded rod 46 is shown, disposed horizontally, as well as the mushroom-shaped clip head 44, located at one of its ends. The threaded rod 46 has helical threads along its entire length, while the clip head 44 adopts a domed structure with curved surfaces, ensuring secure clipping. A flange 42 is located between the clip head 44 and the threaded rod 46.

Thanks to this configuration, the position of the furring clip 40 relative to the base 20 can be precisely adjusted, offering great installation flexibility for both interior and exterior coverings, on various types of wall supports, with or without insulation. In fact, the adjustment of the furring clip 40 allows for correcting wall plumb defects, and/or adding additional insulation between the first insulation and the furring strip or a cable passage between the first insulation and the furring strip. The adjustment can also be performed after clipping the furring strip 200.

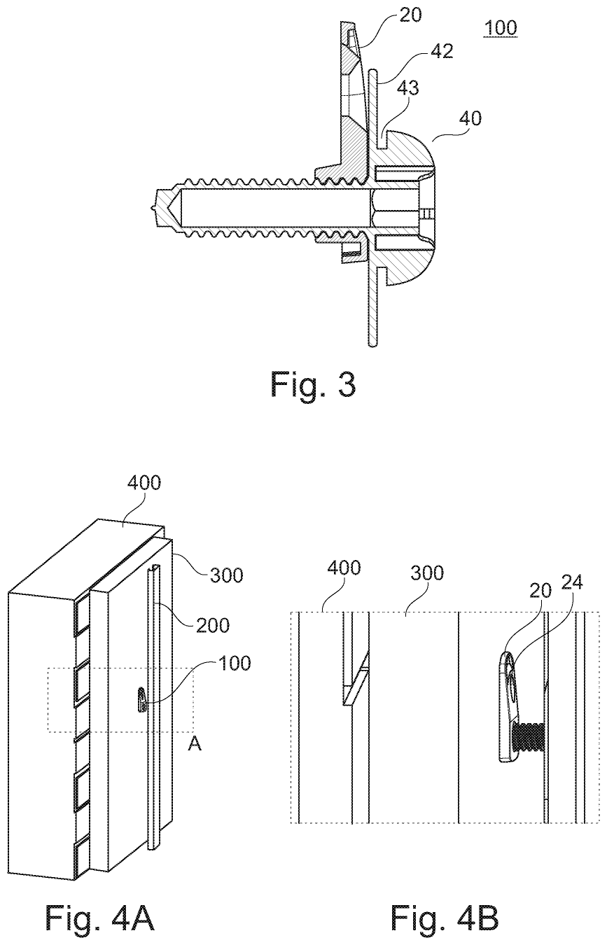

FIG. 3 presents, in cross-section, the adjustable intermediate support 100 according to the present disclosure, highlighting the arrangement and interaction between the base 20 and the furring clip 40.

A particularly noteworthy element lies in the space 43 defined between the flange 42 and the clip head 44. The flange 42 extends laterally from the threaded rod 46, while the mushroom-shaped head 44 is located above.

This space is specifically designed to receive and retain the edges of a furring strip, thus allowing both direct and secure clipping onto the intermediate support. Its dimensions are adapted to ensure reliable grip while allowing easy installation or removal.

Furthermore, the slot 43 provides a certain flexibility during installation, by tolerating slight dimensional variations of the furring strips. This adaptability, combined with the adjustment of the threaded rod 46, allows for quick and efficient installation, while maintaining the versatility offered by the adjustable intermediate support 100.

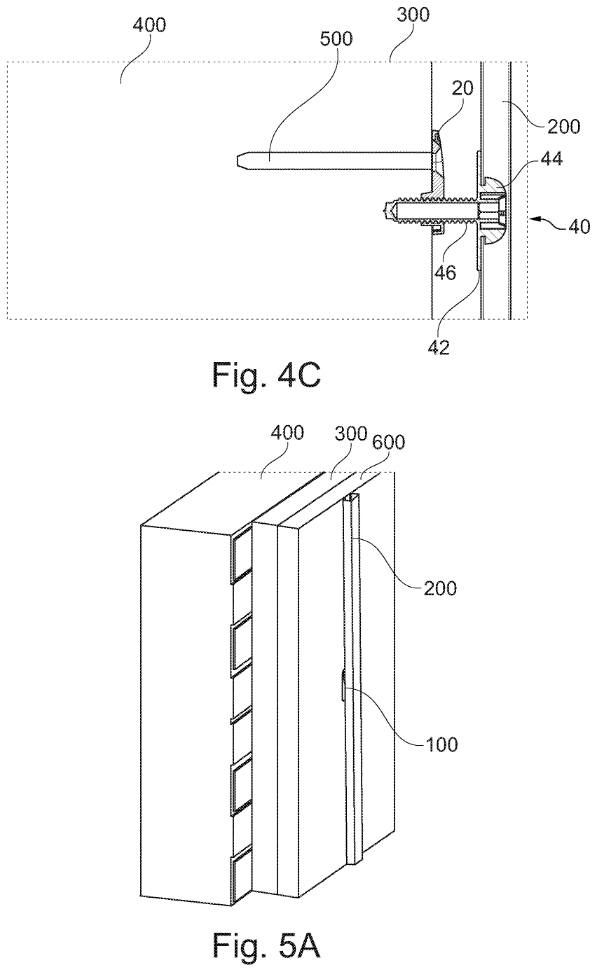

FIG. 4A shows, in perspective, the installation of a furring strip 200 on a rigid insulation 300 and a wall support 400 by means of an adjustable intermediate support 100 according to the present disclosure. In this configuration, the support 100 passes through the rigid insulation 300 to anchor directly to the wall 400, which allows maintaining the thermal efficiency of the insulation while ensuring reliable mounting. The base 20, securely attached to the wall using a wall plug 500, provides a stable foundation, while the furring clip 40, equipped with a threaded rod 46, screws into the base 20 through the insulation 300. The direct fitting of the furring strip 200 onto the clip head 44 ensures robust retention without requiring additional tools and allows precise adjustment of the distance between the furring strip and the wall, thus creating an ideal technical space for cable routing or conduit installation. Moreover, the adjustable length of the threaded rod 46 allows adapting the support to various insulation thicknesses.

FIG. 4B enlarges zone A of FIG. 4A and illustrates in more detail the interface between the support 100, the insulation 300, and the furring strip 200. The clip head 44, designed to fit into the furring strip 200, can be seen, as well as the space formed between the flange 42 and the head, ensuring the stability of the assembly while preserving ease of implementation.

FIG. 4C provides a cross-sectional view of the assembly, revealing in particular the penetration depth of the wall plug 500 into the wall and the manner in which the threaded rod 46 adjusts into the base 20. This arrangement also provides complementary support through the partial insertion of the threaded portion 46 into the insulation 300. Thanks to this system, the interior insulation is easily installed, the furring strip 200 remaining securely held while being adjustable, which facilitates the subsequent installation of the facing and ensures a quality finish.

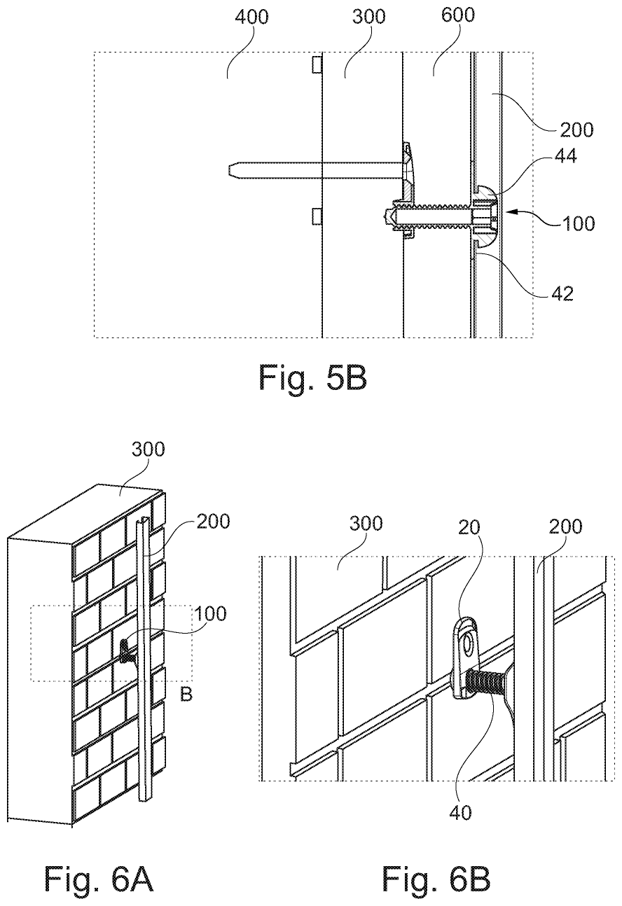

FIG. 5A illustrates, in perspective, how an adjustable intermediate support 100 can simultaneously pass through a rigid insulation 300 and a second insulation 600 for example a fibrous insulation to attach directly to a wall support 400. In this configuration, the base 20 is anchored to the wall using a wall plug 500 or similar device, while the threaded rod 46 of the furring clip 40 engages in the base 20 by passing through both insulation layers. Thus, despite the superposition of different insulating materials, their thermal and acoustic properties are preserved, while the furring strip 200 remains securely attached at an adjustable distance from the wall. This arrangement also demonstrates the robustness of the attachment, even when the cumulative thickness of the insulation is significant.

FIG. 5B presents a cross-sectional view of the assembly described in FIG. 5A, revealing the penetration depth of the wall plug 500 into the wall and the position of the threaded rod 46 inside the base 20. The retention of the furring strip 200 at a precise distance from the wall, thanks to the screwing of the clip 40, can be clearly observed. This free space, located between the fibrous insulation 600 and the future facing, for example the plasterboard not shown, can serve as a technical passage, simplifying the installation of cables or other equipment. Furthermore, the adjustable length of the threaded rod 46 allows adapting the intermediate support to various thicknesses or combinations of insulation, while ensuring simple and efficient installation of the finishing elements.

FIG. 6A illustrates, in perspective, the installation of a furring strip 200 on an exterior wall support 400 without insulation, using an adjustable intermediate support 100 according to the present disclosure. In this embodiment, the base 20 is securely anchored to the exterior wall using a wall plug 500 suitable for outdoor use, while the furring clip 40, provided with a threaded rod 46, is inserted into the threaded hole 26 of the base 20. This configuration proves particularly useful when no insulation is required or when insulation is implemented using a different method, while allowing precise adjustment of the gap between the furring strip 200 and the wall to compensate for any surface irregularities, for example correcting wall plumb defects. Thanks to this adjustment, a ventilated space can also be created between the wall and the future exterior covering (not shown), promoting air circulation and the durability of the cladding.

FIG. 6B provides a detailed view of zone B, highlighting the interface between the support 100 and the furring strip 200. In this detailed view, it can be clearly seen how the clip head 44 fits into the furring strip 200. The space located between the flange 42 and the head 44 firmly holds the edges of the furring strip, which proves crucial in an exterior context exposed to climatic constraints and wind loads. Furthermore, the robust design of the support 100 allows the use of various types of coverings, such as metal or wood cladding, while maintaining easy and adaptable installation. The entire configuration, illustrated in FIG. 6A and FIG. 6B, thus demonstrates the flexibility and strength of the system, which provides an effective solution for mounting exterior coverings on different wall supports, even without an insulating layer.

For the installation of an adjustable intermediate support 100 according to the present disclosure, an installation method is also proposed.

In practice, the method for installing an adjustable intermediate support 100 according to the present disclosure provides, first of all, for the attachment of the base 20. To do this, a hole is drilled through the rigid insulation 300 to the wall support 400, then the base 20 is positioned against the insulation 300. A wall plug 500 is then inserted through the fastening means in the form of a hole 24 of the base 20 and anchored in the wall 400, passing through the insulation 300.

A step of installing the threaded clip 40 follows. The threaded rod 46 of this clip is aligned with the threaded hole 26 of the base 20, then screwed in to adjust the distance between the clip head 44 and the surface of the rigid insulation 300. This adjustment allows for correcting wall plumb defects, and/or adding additional insulation between the first insulation and the furring strip or a cable passage between the first insulation and the furring strip. The adjustment can also be performed after clipping the furring strip 200. Once this distance is deemed satisfactory, the furring strip 200 is clipped. It is sufficient to place the furring strip 200 so as to fit it into the gap between the flange 42 and the head 44, then apply firm pressure to lock it. Advantageously, the clip head 44, which is force-fitted into the furring strip, can then slide freely therein, thus allowing precise adjustment of its position inside the latter.

In an optional embodiment, the method further comprises a step of adjusting the threaded rod 46 in the rigid insulation 300. This adjustment can be performed before the furring strip 200 is clipped onto the clip head 44, or after its clipping, in order to precisely adjust the position of the furring strip 200 relative to the wall. In both cases, this adjustment possibility offers great versatility during implementation, adapting to different insulation thicknesses and ensuring stable retention of the system.

Once the adjustable intermediate supports and furring strips are securely positioned and adjusted, it is then possible to proceed with the installation of the wall panels, whether plasterboards, wood panels, or another suitable material. These are attached directly to the furring strips, thus forming a regular and homogeneous wall. Thanks to the space created between the wall and the panels, it is also possible to conceal cables or technical conduits. Moreover, this modular assembly subsequently facilitates any maintenance or renovation operation.

| Reference Sign | Designation |
|---|---|
| 100 | Adjustable intermediate support |
| 20 | Base |
| 22 | Body |
| 24 | Hole |
| 26 | Threaded hole |
| 40 | Furring clip |
| 42 | Flange |
| 43 | Slot |
| 44 | Clip head |
| 45 | Recess |
| 46 | Threaded rod |
| 200 | Furring strip |
| 300 | Rigid insulation |
| 400 | Wall support |
| 500 | Wall plug |
| 600 | Insulation |

What is claimed is:

1. An adjustable intermediate support, comprising a base and a clip, the base having a contact surface and being provided with fastening means allowing the base to be attached to a support and with a threaded hole, the threaded hole opening at the contact surface, the clip comprising a clip head and a threaded rod, the threaded rod being adapted to be inserted into the threaded hole by screwing, the clip head being intended to cooperate with a furring strip.

2. The adjustable intermediate support according to claim 1, characterized in that the fastening means are a hole opening at the contact surface.

3. The adjustable intermediate support according to claim 1, characterized in that the clip is provided with a flange disposed between the clip head and the rod.

4. The adjustable intermediate support according to claim 1, characterized in that the contact surface is substantially flat.

5. The adjustable intermediate support according to claim 1, characterized in that the flange and the clip head define a space adapted to receive the inner lateral flaps of a furring strip.

6. The adjustable intermediate support according to claim 1, characterized in that the bore constituting the threaded hole extends projecting from the contact surface.

7. The adjustable intermediate support according to claim 1, wherein the clip is made in one piece.

8. The adjustable intermediate support according to claim 1, characterized in that it is made of plastic material.

9. A method for installing an adjustable intermediate support according to claim 1, comprising the following steps:
attaching the base to a wall support by the fastening means;
screwing the threaded clip into the threaded hole of the base, also through the rigid insulation;
clipping a furring strip onto the clip head.

10. The method for installing the adjustable intermediate support according to claim 9, wherein the step of attaching the base is performed using a wall plug, through the fastening means in the form of a hole, passing through a rigid insulation.

11. The method for installing the adjustable intermediate support according to claim 10, characterized in that it comprises the following step:
adjusting the screwing of the threaded rod into the rigid insulation, this allows adjustment of the spacing between the insulation and the clip head.
